(19) United States
(12) Patent Application Publication
(10) Pub. No.: US 2026/0138900 A1
(43) Pub. Date: May 21, 2026

(54) ASSEMBLY TO PROVIDE GRAVITY FED CURVILINEAR MOTION FOR POLYMER RELEASE AND MIXING

(71) Applicant: Gretchen Ming, Elk Grove, CA (US)

(72) Inventor: Gretchen Ming, Elk Grove, CA (US)

(21) Appl. No.: 18/952,664

(22) Filed: Nov. 19, 2024

(51) Int. Cl. C02F 1/68; B01F 21/20; B01F 25/10; B01F 101/00; C02F 1/56; C02F 103/00

(52) U.S. Cl. CPC C02F 1/688; B01F 21/20; B01F 25/10; C02F 1/56; B01F 2101/305; C02F 2103/001; C02F 2301/026

(57) ABSTRACT

An assembly for providing gravity fed curvilinear motion for polymer release and mixing is disclosed, including one or more fluid inputs to direct the flow of a fluid into a reservoir constructed to promote curvilinear motion to the fluid. A plurality of polymer forms are composed of a polymer and are positioned within the reservoir such that the polymer is discharged into the fluid. The curvilinear motion of the fluid increases the rate of discharge of the polymer into the fluid to result in the treatment of the fluid.

### TECHNICAL FIELD

The embodiments disclosed herein generally relate to storm water treatment systems for passive water treatment.

### BACKGROUND

Water treatment includes the process of collecting water and treating the water to remove dirt and other contaminants. Often, the treatment of water is required, especially for stormwater and construction site runoff which can contaminate downstream water sources.

The California State Water Resources Control Board released a new Nation Pollutant Discharge Elimination System (NPDES) General Permit for stormwater discharges associated with construction and land disturbance activities. This new permit took effect on Sep. 1, 2023, and included a new attachment, Attachment G, which allows for the use of passive water treatment on construction sites.

Passive water treatment according to the permit is the application of natural or synthetic chemicals and products to reduce turbidity in discharges through coagulation and flocculation. The permit also further specifies that passive treatment does not rely on computerized, enclosed systems with pumps, filters, and real-time controls. Passive treatment may include pumps where they are necessary to move water around the site.”

The current solution to passive treatment is on a case-by-case basis. The most common methods used to dose water using anionic polyacrylamides (PAMs) involve carving into the existing land or using existing channels and modifying them to fit the developer or designer's needs.

A common system used for residential dredging operation uses a baffle grid system, with a line of jute panels to catch the sediment. The drawbacks of this design are the footprint of the project, the necessary labor, and the waste that it produces. In most scenarios, contractors desire the smallest footprint possible for water treatment so they can work on as much of their project site as possible. Therefore, it is not always feasible to have an area large enough to conduct a 700-800 GPM system. Another drawback is the labor needed to set up the design. A laborer would be needed, as well as an excavator, to dig the pit for the system and then more labor would be needed to set up the baffle system. The materials used are also wasteful and most likely will be used once and then sent to the dump, which is not environmentally conscious.

Another system that is commonly used is the idea or concept of a batch. The polymer bricks are left in a tank for a certain amount of time and then water is run into the tank and water spills out over the top. However, this is not a consistent way to treat water because the residency time for the water will be different for the water that was initially in the tank. It also wastes polymer. Initially the polymer concentration in the water is typically higher than necessary to treat the water and can lead to overtreatment and undertreatment as time progresses over the dosing process.

Semi-passive systems offer another way to treat water. Semi-passive treatment systems typically use pumps to move water through a system, but do not use any other outside energy source. The Federal Register claims that an advantage of semi-passive approaches is that since the water is withdrawn by pumping (although semi-passive dosing can be accomplished using gravity flow in certain cases), flowrates and dosing rates can be more easily controlled, allowing for more consistent and likely better performance. Since the water is being moved using a pump and not just gravity, it gives way an opportunity to have more accurate reading on flow rate and how many gallons of water are being treated. However, a disadvantage may be that achieving a consistent level of performance may be more difficult due to variations in storm flows and sediment loads and little control over dosage rates.

### SUMMARY OF THE INVENTION

This summary is provided to introduce a variety of concepts in a simplified form that is further disclosed in the detailed description of the embodiments. This summary is not intended for determining the scope of the claimed subject matter.

An assembly for providing gravity fed curvilinear motion for polymer release and mixing is disclosed, including one or more fluid inputs to direct the flow of a fluid into a reservoir constructed to promote curvilinear motion to the fluid. A plurality of polymer forms are composed of a polymer and are positioned within the reservoir such that the polymer is discharged into the fluid. The curvilinear motion of the fluid increases the rate of discharge of the polymer into the fluid to result in the treatment of the fluid.

In one aspect, the fluid inputs are arranged to receive and direct the flow of stormwater into the reservoir.

In one aspect, the reservoir includes an outlet to enable the egress of the fluid therethrough.

In one aspect, the polymer is a flocculant to treat the fluid within the reservoir.

In one aspect, the construction of the reservoir provides the curvilinear direction of the fluid to increases friction between the fluid and the plurality of polymer forms to effectively treat the stormwater before its egress through the outlet.

In one aspect, each of the plurality of polymer forms are connected to the reservoir via a tether.

The embodiments are configured to remove turbidity from the water and uses anionic polyacrylamides (PAMs) to encourage flocculation of the sediment in the water. It may use a 4″ pump to move water into a manifold that leads to the mixing device where the water is then gravity fed through the system lined with jute to allow time for the sediment to settle out of the water or other ways the water exits the reservoir. The system will allow for repeatability and customization based on the turbidity of the water or the flow rate required on site. According to the U.S. EPA Federal Register the design would be considered “semi-passive” but would still be in compliance with the NPDES General Permit. The system may also be used in a permanent manner.

This system would greatly reduce the cost of water treatment on construction sites and cut labor costs. The anionic PAMs are much more cost effective than the cationic polymers that are typically used in Active Treatment Systems (ATS), such as chitosan. ATS systems typically include rigorous training for operators to learn how to operate the systems and while the operators of the passive treatment systems will also need training, it is a simpler and less extensive learning curve.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the assembly for providing gravity fed curvilinear motion for polymer release and mixing for the purposes of treating water, according to some embodiments;

FIG. 2 illustrates a perspective view of the assembly for providing gravity fed curvilinear motion for polymer release and mixing for the purposes of treating water, according to some embodiments; and

FIG. 3 illustrates a perspective view of the bottom of the reservoir including the outlet, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to an assembly for providing gravity fed curvilinear motion for polymer release and mixing which is used to efficiently treat water, such as runoff from a construction site or in environments which can receive high turbidity water. The assembly includes fluid inputs which receive the turbid fluid and direct the flow the fluid into a reservoir constructed to promote curvilinear motion of the fluid. Polymer forms are positioned within the reservoir and the fluid flows around the polymer forms, causing the discharge of the polymer into the fluid. The curvilinear motion of the fluid increases the rate of discharge of the polymer to result in the treatment of the fluid.

The configuration of the reservoir is such that it promotes the curvilinear motion of the fluid. This is beneficial in increasing friction between the fluid and the polymer forms, causing an increase in the rate at which the polymer is discharged (i.e., disintegration) into the fluid, and thus increases the efficiency of the water treatment process. The curvilinear motion of the fluid also promotes the mixing of fluid in a condensed area.

The assembly is designed to allow for the fluid to enter at a high velocity and move along the curve of the bowl, coming in contact with polymer that is positioned in the flow of water. The continued motion along the landscape of the reservoir allows for the water to then mix and collide with other particles to promotes the flocculation of sediment in the water.

The preliminary tests showed an 81% reduction of turbidity in the water after passing through the prototype and a 95% reduction when the water was passed over jute, whereas the standard method only had a 49% reduction and 58.6% reduction in turbidity.

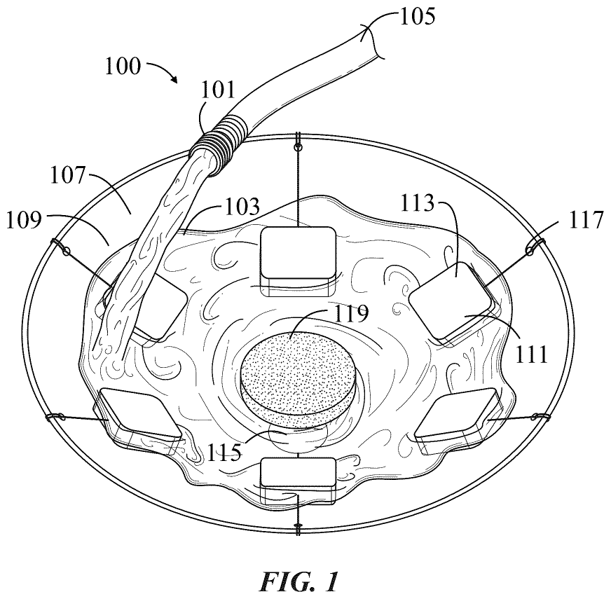

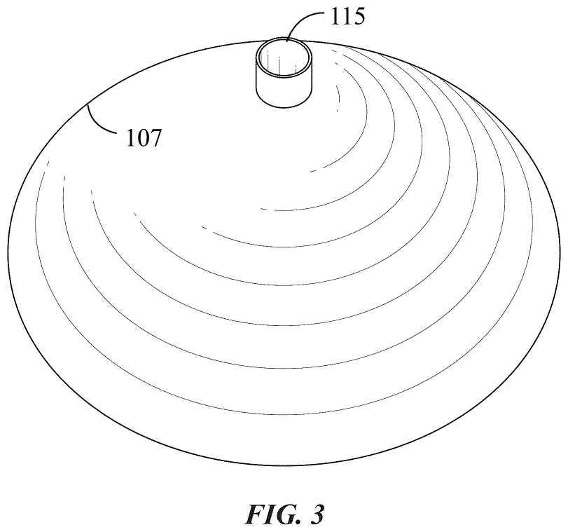

FIG. 1 illustrates the assembly 100 which provides gravity fed curvilinear motion for polymer release and mixing for the purposes of treating a turbid fluid (i.e., construction water runoff, stormwater runoff, etc.). One or more fluid inputs 101 collect fluid 103 from a water source 105 and direct the flow of the fluid into a reservoir 107. The reservoir 107 is shaped to provide curvilinear motion to the fluid 103 once it enters the interior of the reservoir 107. The reservoir 107 is constructed having a conical, frustoconical or similar shape such that the fluid enters the interior 109 and begins moving in a curvilinear motion. A plurality of polymer forms 111 are comprised of a polymer 113 and are positioned within the reservoir 107. This allows the fluid 103 to contact the polymer forms 111 thus causing the polymer 113 to disintegrate. In such, the polymer acts as a flocculant to treat the fluid before it exits through an outlet 115. In such, the fluid exiting the outlet 115 (also see FIG. 3) is treated. Each polymer form 111 may be connected to the reservoir 107 which holds the polymer forms 111 within the reservoir 107. A container 119 is positioned within the reservoir 107 to increase the exposure time between the fluid 103 and the polymer forms 111.

In some embodiments, the fluid inputs 101 are designed to direct the flow of the fluid 103 at a sufficient velocity to cause the fluid to flow in a curvilinear motion. In such, the system operates without the need for external power sources by utilizing the force of gravity to drive the flow of the fluid 103.

In some embodiments, a pump may be included to forcibly direct the flow of the fluid into the fluid inputs 101. The pump may be advantageous if gravity is insufficient in moving the fluid 103 at a rate necessary for causing curvilinear motion within the reservoir 107.

In some embodiments, the polymer 113 may be any polymer known in the arts which acts as a flocculant. The polymer 113 may be a long negatively charged molecule which binds to soil and other contaminants within the water.

In some embodiments, the polymer 113 may be configured as a polymer mat or another similar form which enables the polymer 113 to dissolve, disintegrate, or otherwise diffuse into the fluid.

In some embodiments, the reservoir 107 is beneficial by increasing the contact time between the turbid fluid and the polymer, thus increasing the efficiency of the polymer and its ability to treat the fluid prior to its egress through the output. The curvilinear motion increases the likelihood of the polymer colliding with sediment particles within the turbid water.

The assembly 100 described herein provide a portable, cost-efficient, compact, and efficient means of treating turbid fluid. The assembly is simple to use and does not require external power sources, which may be inefficient, costly, and/or unfeasible in some applications and locations.

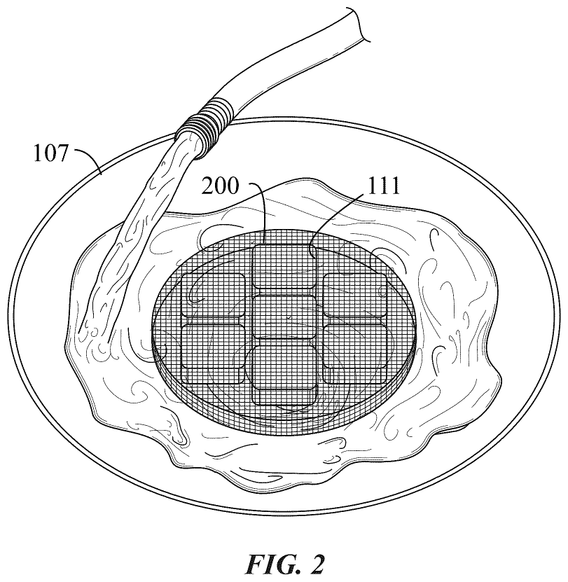

To maintain the polymer forms 111 within the reservoir 107 various means may be used including a tether 117 (as shown in FIG. 1) or an enclosure 200 (as is shown in FIG. 2). The polymer forms 111 may also simply be free floating within the reservoir 107 or may be retained therein using other methods of attaching the polymer to the reservoir 107. In the specific example illustrated in FIG. 2, the enclosure 200 is a cage-type structure which allows water to flow through the openings, while retaining the polymer forms 111 within the reservoir 107 by preventing the large polymer 113 pieces from exiting the enclosure 200.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An assembly for providing gravity fed curvilinear motion for polymer release and
mixing, comprising:
one or more fluid inputs to direct the flow of a fluid into a reservoir constructed to promote curvilinear motion to the fluid;
a plurality of polymer forms composed of a polymer, the plurality of polymer forms positioned within the reservoir, wherein the fluid flows around the plurality of polymer forms to discharge the polymer into the fluid,
wherein the curvilinear motion of the fluid increases the rate of discharge of the polymer into the fluid to result in the treatment of the fluid.

2. The assembly of claim 1, wherein the fluid inputs are arranged to receive and direct the flow of stormwater into the reservoir.

3. The assembly of claim 2, wherein the reservoir includes an outlet to enable the egress of the fluid therethrough.

4. The assembly of claim 3, wherein the polymer is a flocculant to treat the fluid within the reservoir.

5. The assembly of claim 4, wherein the construction of the reservoir provides the curvilinear direction of the fluid to increases friction between the fluid and the plurality of polymer forms to effectively treat the stormwater before its egress through the outlet.

6. The assembly of claim 5, wherein each of the plurality of polymer forms are connected to the reservoir.

7. An assembly for providing gravity fed curvilinear motion for polymer release and mixing, comprising:
one or more fluid inputs to direct the flow of a fluid into a reservoir constructed to promote curvilinear motion to the fluid;
a plurality of polymer forms including a polymer, the plurality of polymer forms positioned within the reservoir to allow the polymer to disintegrate into the fluid, wherein the fluid flows around the plurality of polymer forms to discharge the polymer into the water,
wherein the curvilinear motion of the fluid increases the rate of discharge of the polymer into the fluid to reduce the turbidity of the fluid prior to its egress through an output;
a container positioned within the reservoir to increase the exposure time between the fluid and the plurality of polymer forms.

8. The assembly of claim 7, wherein the fluid inputs are arranged to receive and direct the flow of stormwater into the reservoir.

9. The assembly of claim 8, wherein the reservoir includes an outlet to enable the egress of the fluid therethrough.

10. The assembly of claim 9, wherein the polymer is a flocculant to treat the fluid within the reservoir.

11. The assembly of claim 10, wherein the construction of the reservoir provides the curvilinear direction of the fluid to increases friction between the fluid and the plurality of polymer forms to effectively treat the stormwater before its egress through the outlet.

12. The assembly of claim 11, wherein each of the plurality of polymer forms are connected to the reservoir.

13. A method for reducing the turbidity of stormwater, the method comprising the steps of:
connecting a plurality of polymer forms to a reservoir;
positioning a container within the reservoir; and
receiving gravity fed stormwater using one or more fluid inputs in fluid communication with the reservoir to direct the flow of stormwater into the reservoir,
wherein the reservoir is constructed to promote curvilinear motion of the stormwater therein, and wherein the curvilinear motion increases the friction between the stormwater and the plurality of polymer forms to cause the disintegration of the polymer forms causing the reduction in turbidity of the stormwater.

14. The method of claim 13, wherein the container reduces the outflow of the treated stormwater from the reservoir to increase the time of contact between the plurality of polymer forms and the stormwater.

15. The method of claim 14, wherein the reservoir includes an outlet to enable the egress of the stormwater therethrough.

16. The method of claim 15, wherein the polymer is a flocculant to treat the stormwater within the reservoir.

17. The method of claim 16, wherein the dimensions of the one or more fluid inputs regulates the flow rate of the stormwater into the reservoir.
